(19) United States
(12) Patent Application Publication
(10) Pub. No.: US 2013/0145784 A1
(43) Pub. Date: Jun. 13, 2013

(54) HEATING, VENTILATION AND AIR CONDITIONING SYSTEM USER INTERFACE HAVING SERVICE REMINDERS ON A SINGLE SCREEN AND METHOD OF OPERATION THEREOF

(71) Applicants: Larry S. Bias, Prosper, TX (US); Daniel Castillo, Plano, TX (US); Bobby DiFulgentiz, Frisco, TX (US); Gabaza B. Mlambo, McKinney, TX (US); Stephen J. Vendt, Little Elm, TX (US)

(72) Inventors: Larry S. Bias, Prosper, TX (US); Daniel Castillo, Plano, TX (US); Bobby DiFulgentiz, Frisco, TX (US); Gabaza B. Mlambo, McKinney, TX (US); Stephen J. Vendt, Little Elm, TX (US)

(73) Assignee: Lennox Industries Inc., Richardson, TX (US)

(21) Appl. No.: 13/432,668

(22) Filed: Mar. 28, 2012

Related U.S. Application Data
(60) Provisional application No. 61/569,859, filed on Dec. 13, 2011.

(51) Int. Cl. F25B 49/02; G08B 1/00; F25B 49/00; G06F 3/041

(52) U.S. Cl. 62/129; 345/173; 340/309.4; 62/125

(57) ABSTRACT

A user interface for use with an HVAC system, a method of providing service reminders on a single screen of a user interface of an HVAC system and an HVAC system incorporating the user interface or the method. In one embodiment, the user interface includes: (1) a display configured to provide information to a user, (2) a touchpad configured to accept input from the user and (3) a processor and memory coupled to the display and the touchpad and configured to drive the display, the display further configured to display a screen with a layout containing multiple service reminders pertaining to the HVAC system.

### CROSS-REFERENCE TO RELATED APPLICATION

This application claims the benefit of U.S. Provisional application Ser. No. 61/569,859, filed by Bias, et al., on Dec. 13, 2011, entitled “Heating, Ventilation and Air Conditioning System User Interface Having One or More of One-Touch Away Feature, Adjustable Fonts, Proportional Animation Graphics, Service Reminders on a Single Screen, Separate Programming and Manual Mode Screens, Integrated Screen/Housing Skin, Low-Profile Housing, Secure Functional Upgrade Feature and Remote Platform Access Application Associated Therewith,” commonly assigned with this application and incorporated herein by reference.

### TECHNICAL FIELD

This application is directed, in general, to a heating, ventilation and air conditioning (HVAC) systems and, more specifically, to an HVAC system having a user interface, such as a thermostat.

### BACKGROUND

Users interact with HVAC systems through user interfaces. The most common user interface employed today is the thermostat. The most basic thermostats feature one or more dials, switches or levers and allow users to set temperatures. More elaborate thermostats feature a liquid crystal display (LCD) screen, perhaps even of the touchscreen variety, and allow users to program their HVAC systems for automatic temperature settings, configure and maintain their HVAC systems and records of historical operation data, allowing the users to gauge the performance and efficiency of their HVAC systems.

Thermostats necessarily include both temperature sensors and control circuitry within their housings. Some user interfaces do not qualify as thermostats, because while they communicate with temperature sensors and control circuitry, they do not include both within their housings.

### SUMMARY

One aspect provides a user interface. In one embodiment, the user interface includes: (1) a display configured to provide information to a user, (2) a touchpad configured to accept input from the user and (3) a processor and memory coupled to the display and the touchpad and configured to drive the display, the display further configured to display a screen with a layout containing multiple service reminders pertaining to the HVAC system.

Another aspect provides a method of providing service reminders on a single screen of a user interface of an HVAC system. In one embodiment, the method includes: (1) providing information to a user with a display, (2) accepting input from the user with a touchpad and (3) causing the display to display a screen with a layout containing multiple service reminders pertaining to the HVAC system.

Yet another aspect provides an HVAC system. In one embodiment, the HVAC system includes: (1) a heat pump or a compressor having at least one stage, (2) at least one condenser coil, (3) an expansion valve, (4) at least one evaporator coil, (5) a loop of pipe interconnecting the heat pump or compressor, the at least one condenser coil, the expansion valve and the at least one evaporator coil and containing a refrigerant, (6) at least one fan configured to cause outdoor air and indoor air to blow over the at least one condenser coil and the least one evaporator coil and (7) a user interface, including: (7a) a display configured to provide information to a user, (7b) a touchpad configured to accept input from the user and (7c) a processor and memory coupled to the display and the touchpad and configured to drive the display, the display further configured alternatively to display a screen with a layout containing multiple service reminders pertaining to the HVAC system.

### BRIEF DESCRIPTION

Reference is now made to the following descriptions taken in conjunction with the accompanying drawings, in which:

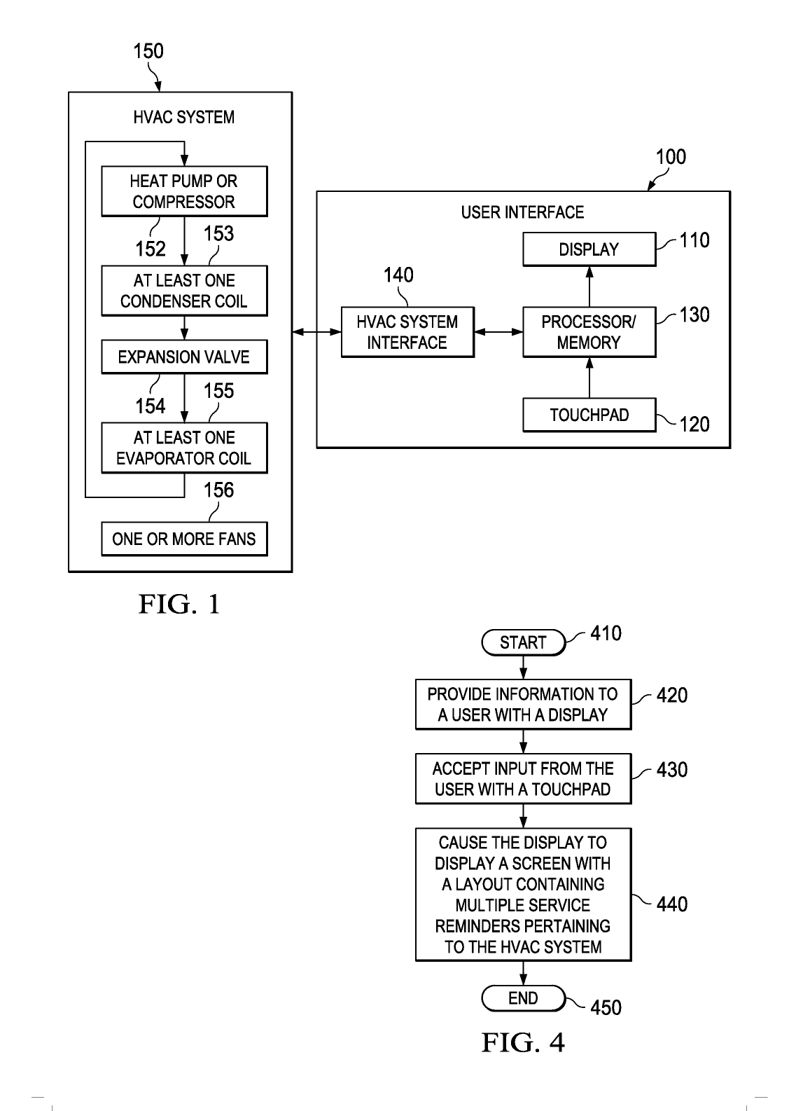

FIG. 1 is a block diagram of one embodiment of a user interface;

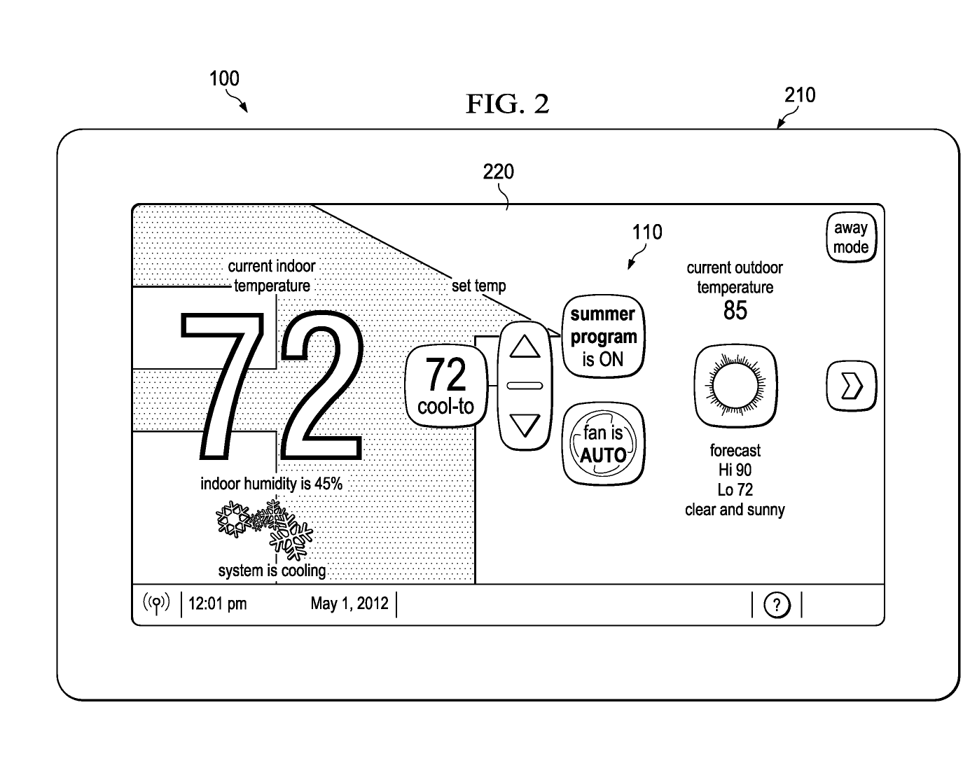

FIG. 2 is a front-side elevational view of one embodiment of a user interface;

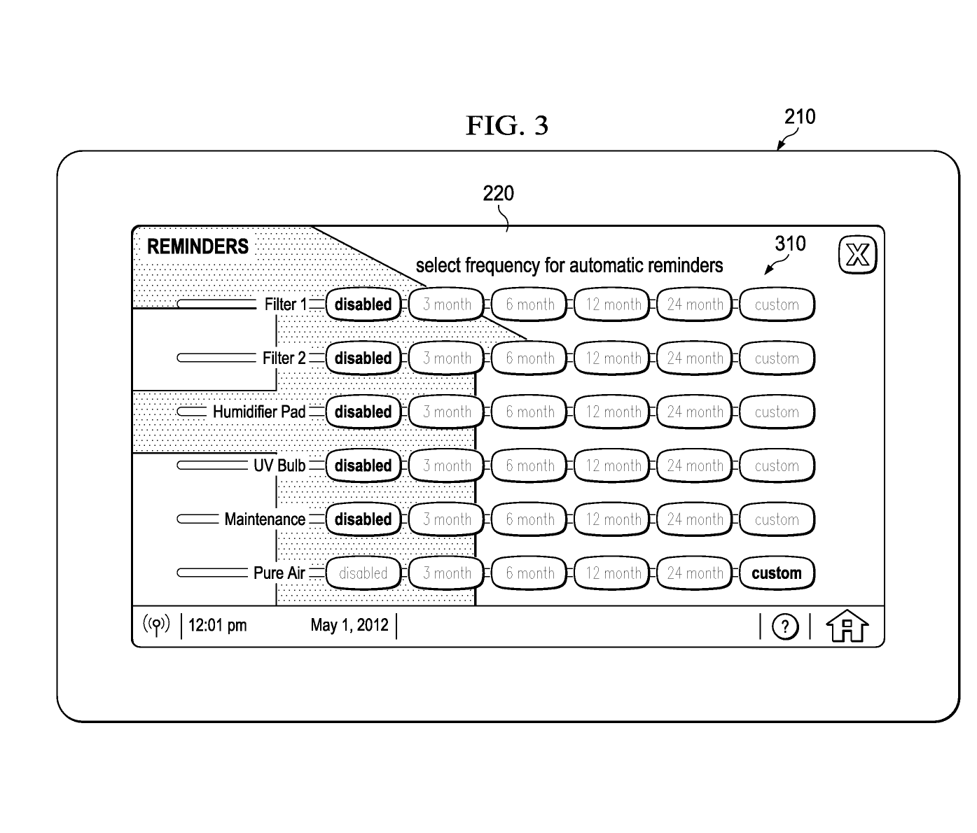

FIG. 3 is a representation of one embodiment of a screen of the user interface of FIG. 2 having one embodiment of service reminders on a single screen; and

FIG. 4 is a flow diagram of one embodiment of a method of providing service reminders on a single screen.

### DETAILED DESCRIPTION

FIG. 1 is a block diagram of one embodiment of a user interface 100. The interface has a display 110 and a touchpad 120. The display 110 is configured to provide information to a user, and the touchpad 120 is configured to accept input from a user. A processor and memory 130 are coupled to the display 110 and the touchpad 120 to drive the display 110 and process the input from the touchpad 120. More accurately, software or firmware is loaded into and stored in the memory and, when executed in the processor, configures the processor to drive the display 110 and process the input from the touchpad 120. An HVAC system interface 140 is coupled to the processor and memory 130 and is configured to provide communication between the processor and memory 130 and the remainder of an HVAC system 150. In various embodiments, the HVAC system 150 includes one or more loops of pipe (one being shown and referenced as 151) containing a refrigerant. Each loop transports the refrigerant among a heat pump or a compressor 152 having at least one stage, at least one condenser coil 153, an expansion valve 154 and at least one evaporator coil 155. One or more fans (“blowers”) 156 cause outdoor air and indoor air to blow over the at least one condenser coil 153 and the at least one evaporator coil 155 to transfer heat to or from them. Those skilled in the pertinent art are familiar with conventional HVAC systems and generally understand the many embodiments and forms they may take.

FIG. 2 is a front-side elevational view of one embodiment of the user interface of FIG. 1. The user interface 100 has a bezel 210. The display 110 is configured to display at least one screen 220 of information for the benefit of a user (the term also including an installer or any other person interested in gaining information from the user interface 100).

Although unreferenced, the screen 220 shown in FIG. 2 includes a current temperature display portion, a setpoint temperature display portion, buttons to raise or lower the setpoint temperature, a system mode message display portion (i.e., “system is heating”) and a program status message display portion (i.e., “program is on”). The screen 220 also has current date and time display portions and allows the user to display other screens (via a “press for more” message).

FIG. 3 is a representation of one embodiment of a screen of the user interface of FIG. 2 having one embodiment of service reminders on a single screen, exemplified by a layout 310.

This feature makes it easier to set up service reminders on a user interface. Today's user interfaces require multiple pages, tabs, or screens to set or view service reminders. The layout 310 shows all service reminders and the reoccurrence timing for which they are set on one screen. The service reminders pertain to replacing two filters, “Filter 1” and “Filter 2,” replacing a humidifier pad, replacing an ultraviolet (UV) bulb, performing a routine system check (“Maintenance”) and checking an air purifier (“Pure Air”). As is apparent in the embodiment of FIG. 3, the reoccurrence timing (“frequency for automatic reminders”) includes the following selections: “disabled” (off), “3 month” (every three months), “6 month” (every six months), “12 month” (every 12 months), “24 month” (every 24 months) and “custom” (allowing a user to select from a broader range of recurrence times or frequencies, e.g., expressed in whole months). This makes it easy for a user to set reminders in only a few touches. In various embodiments, the user interface displays all reminders on one screen, users can see all their reminders at once and users can see their entire reminder plan on one screen. In the illustrated embodiment, a user selects a “reminders” button on another screen, causing the layout 310 to be displayed. All reminders are displayed with selectable buttons. The user selects the time period for each reminder.

FIG. 4 is a flow diagram of one embodiment of a method of providing service reminders on a single screen. The method begins in a start step 410. In a step 420, information is provided to a user with a display. In a step 430, input from the user is accepted with a touchpad. In a step 440, the display is caused to display a screen with a layout containing multiple service reminders pertaining to the HVAC system. The method ends in an end step 450.

Those skilled in the art to which this application relates will appreciate that other and further additions, deletions, substitutions and modifications may be made to the described embodiments.

In the claims:

1. A user interface for use with an HVAC system, comprising:
a display configured to provide information to a user; and
a processor and memory coupled to said display and configured to drive said display, said display further configured to display a screen with a layout containing multiple service reminders pertaining to said HVAC system.

2. The user interface as recited in claim 1 wherein said layout contains all service reminders pertaining to said HVAC system.

3. The user interface as recited in claim 1 wherein said service reminders pertain to at least two of:
replacing a filter,
replacing a humidifier pad,
replacing an ultraviolet bulb,
performing a routine system check, and
checking an air purifier.

4. The user interface as recited in claim 1 wherein at least some of said service reminders have recurrence timings selected from the group consisting of:
off,
every three months,
every six months,
every 12 months,
every 24 months, and
custom.

5. A method of providing service reminders on a single screen of a user interface of an HVAC system, comprising:
providing information to a user with a display;
accepting input from said user; and
causing said display to display a screen with a layout containing multiple service reminders pertaining to said HVAC system.

6. The method as recited in claim 5 wherein said layout contains all service reminders pertaining to said HVAC system.

7. The method as recited in claim 5 wherein said service reminders pertain to at least two of:
replacing a filter,
replacing a humidifier pad,
replacing an ultraviolet bulb,
performing a routine system check, and
checking an air purifier.

8. The method as recited in claim 5 wherein at least some of said service reminders have recurrence timings selected from the group consisting of:
off,
every three months,
every six months,
every 12 months,
every 24 months, and
custom.

9. An HVAC system, comprising:
a heat pump or a compressor having at least one stage;
at least one condenser coil;
an expansion valve;
at least one evaporator coil;
a loop of pipe interconnecting said heat pump or compressor, said at least one condenser coil, said expansion valve and said at least one evaporator coil and containing a refrigerant;
at least one fan configured to cause outdoor air and indoor air to blow over said at least one condenser coil and said least one evaporator coil; and
a user interface, including:
a display configured to provide information to a user,
a touchpad configured to accept input from said user, and
a processor and memory coupled to said display and said touchpad and configured to drive said display, said display further configured alternatively to display a screen with a layout containing multiple service reminders pertaining to said HVAC system.

10. The HVAC system as recited in claim 9 wherein said layout contains all service reminders pertaining to said HVAC system.

11. The HVAC system as recited in claim 9 wherein said service reminders pertain to at least two of:
replacing a filter,
replacing a humidifier pad,
replacing an ultraviolet bulb,
performing a routine system check, and
checking an air purifier.

12. The HVAC system as recited in claim 9 wherein at least some of said service reminders have recurrence timings selected from the group consisting of:
off,
every three months,
every six months,
every 12 months,
every 24 months, and
custom.
